(19) United States
(12) Patent Application Publication
(10) Pub. No.: US 2015/0161914 A1
(43) Pub. Date: Jun. 11, 2015

(54) METHOD AND SYSTEM FOR PREPARING SYSTEMATIZED GROUPINGS OF MULTIPLICATION MEMORIZATION PROBLEMS

(71) Applicant: Randolph Palisoc, Los Angeles, CA (US)

(72) Inventor: Randolph Palisoc, Los Angeles, CA (US)

(21) Appl. No.: 14/165,056

(22) Filed: Jan. 27, 2014

Related U.S. Application Data
(60) Provisional application No. 61/914,474, filed on Dec. 11, 2013.

(51) Int. Cl. G09B 23/02

(52) U.S. Cl. CPC G09B 23/02

(57) ABSTRACT

A system for preparing multiplication memorization problems includes:
a) a tangible processor programed to:
   i) separate the integers 1-9 into three groups of integers, a first group consisting of 1, 2 and 3, a second group consisting of 4, 5 and 6 and a third group consisting of 7, 8 and 9; and
   ii) assemble a grouping of multiplication memorization problems wherein in each problem (A) the multiplier is an integer between 1 and 9, and the multiplicand consists of a plurality of integers, including one integer from each of the three groups of integers, (B) the multipliers in the grouping are the same, and (C) the multiplicands in the grouping are different from one another; and
b) a display device for displaying the grouping.

### RELATED APPLICATION

This application claims priority from U.S. Patent Application Ser. No. 61/914,474, entitled “A METHOD AND SYSTEM FOR PREPARING SYSTEMATIZED GROUPINGS OF MULTIPLICATION MEMORIZATION PROBLEMS,” filed Dec. 11, 2013, the entirety of which is incorporated herein by reference.

### FIELD OF THE INVENTION

This invention relates generally to methods and systems for preparing teaching materials, and, more specifically to methods and systems for preparing multiplication study exercises.

### BACKGROUND OF THE INVENTION

In order for today's school children to be prepared for the careers of the future and to compete in the global economy, they must have stronger skills than ever before, including skills in science, technology, engineering, and math. Math skills are of particular importance because the fields of science, technology, and engineering are highly dependent on students' fluency in mathematics.

However, as students progress from elementary school to middle school and on to high school, many of them are unsuccessful in reaching proficiency in higher-level math, and many high school students struggle to get past even beginning Algebra. A key reason that even high school students struggle in Algebra is that they do not have a solid foundation in basic concepts such as fractions, proportions, decimals, percents, and geometry, which are all skills covered in middle school.

Subsequently, what all these basic middle school concepts have in common is that they all necessitate that students memorize their multiplication facts, which should have been learned in elementary school in the third grade.

Unfortunately, many students fail to memorize their basic multiplication facts in elementary school because schools, teachers, and parents have no system of having children memorize their multiplication facts other than using rote memory and using ineffectively designed worksheets. As a result of these existing materials being poorly designed and not being able to adequately prepare students in elementary school, it has long-term negative consequences for their learning through middle school, high school, and into their adult lives.

If one looks at multiplication workbooks currently on the market, one will find that these workbooks are poorly designed and rely on a random arrangement of multiplication facts, expecting that rote memory will eventually do the trick. This random collection of facts in existing workbooks is an ineffective method in helping students memorize their basic yet essential multiplication facts. These existing worksheets make learning the multiplication facts tedious and cumbersome, creating a dislike of mathematics among students as they struggle to memorize their facts.

This patent application describes a new and useful process for designing more effective multiplication worksheets in both paper and digital formats that make it far easier for students to memorize their multiplication facts. It takes advantage of how the brain learns best, but it is non-obvious even to educators because the traditional approach is to just use rote memory and “drill and kill” The method of creating worksheets is not “drill and kill,” but rather automatically generates worksheets that systematically lead to long-term memory of the essential multiplication facts, which are an essential element for success in higher-level math.

Accordingly, there is a need for a better way to learn multiplication.

### SUMMARY OF THE INVENTION

The invention satisfies this need. In one aspect, the invention is a method of preparing systematized groupings of multiplication memorization problems comprising the steps of:

a) separating the integers 1-9 into three groups of integers, a first group consisting of 1, 2 and 3, a second group consisting of 4, 5 and 6 and a third group consisting of 7, 8 and 9; and

b) assembling a grouping of multiplication memorization problems wherein in each problem (i) the multiplier is an integer between 1 and 9 (multi-digit multipliers can also be used once the single digit multipliers have been mastered by students), and (ii) the multiplicand consists of a plurality of integers, including one integer from each of the three groups of integers;

wherein the multipliers in the grouping of multiplication memorization problems are the same, and wherein the multiplicands in the grouping of multiplication memorization problems are different from one another.

In another aspect, the invention is a system for carrying out the method of the invention. In one aspect of such system, the invention is a system for preparing systematized groupings of multiplication memorization problems comprising:

a) a tangible processor programed to:

i) separate the integers 1-9 into three groups of integers, a first group consisting of 1, 2 and 3, a second group consisting of 4, 5 and 6 and a third group consisting of 7, 8 and 9; and
ii) assemble a grouping of multiplication memorization problems wherein in each problem (A) the multiplier is an integer between 1 and 9 (multi-digit multipliers can also be used once the single digit multipliers have been mastered by students), and (B) the multiplicand consists of a plurality of integers, including one integer from each of the three groups of integers;

wherein the multipliers in the grouping of multiplication memorization problems are the same, and wherein the multiplicands in the grouping of multiplication memorization problems are different from one another; and

b) a display device for displaying the grouping of multiplication memorization problems.

### DRAWINGS

These and other features, aspects and advantages of the present invention will become better understood with reference to the following description, appended claims, and accompanying drawings where:

FIG. 1 illustrates a hard copy worksheet created by the invention for practicing multiplying by 5 printed out on paper; and

FIG. 2 illustrates an interactive display page from a software program useable in the invention.

### DETAILED DESCRIPTION OF THE INVENTION

The following discussion describes in detail one embodiment of the invention and several variations of that embodiment. This discussion should not be construed, however, as limiting the invention to those particular embodiments. Practitioners skilled in the art will recognize numerous other embodiments as well.

### DEFINITIONS

As used herein, the following terms and variations thereof have the meanings given below, unless a different meaning is clearly intended by the context in which such term is used.

The terms “a,” “an,” and “the” and similar referents used herein are to be construed to cover both the singular and the plural unless their usage in context indicates otherwise.

As used in this disclosure, the term “comprise” and variations of the term, such as “comprising” and “comprises,” are not intended to exclude other additives, components, integers, ingredients or steps.

### The Method of the Invention

In one aspect of the invention, the invention is a method of preparing systematized groupings of multiplication memorization problems comprising the steps of:

a) separating the integers 1-9 into three groups of integers, a first group consisting of 1, 2 and 3, a second group consisting of 4, 5 and 6 and a third group consisting of 7, 8 and 9; and

b) assembling a grouping of multiplication memorization problems wherein in each problem (i) the multiplier is an integer between 1 and 9 (multi-digit multipliers can also be used once the single digit multipliers have been mastered by students), and (ii) the multiplicand consists of a plurality of integers, including one integer from each of the three groups of integers;

wherein the multipliers in the grouping of multiplication memorization problems are the same, and wherein the multiplicands in the grouping of multiplication memorization problems are different from one another.

### Understanding the Method—why Current Methods of Creating Worksheets are Ineffective

In elementary school, students are supposed to learn all their basic single-digit multiplication facts from the “zeroes” through the “nines.” For example, the “sevens” consist of:
7×0
7×1
7×2
7×3
7×4
7×5
7×6
7×7
7×8
7×9

In all, there are ten facts that students need to learn for the sevens: 7 times 0, 1, 2, 3, 4, 5, 6, 7, 8, and 9.

Unfortunately, short-term memory in humans has limited capacity, and people have a hard time using short-term memory to remember even a seemingly short list of ten items (think about how difficult it is to remember a shopping list and how easy it is to forget that you were supposed to buy milk until you got home).

For young children, even remembering four items in short-term memory is difficult. Long-term memory in humans, on the other hand, has a much greater capacity than short-term memory, and people can store vast amounts of information in their long-term memory. The trick, then, is how to get students to move the facts that they are trying to memorize from their limited, short-term memory into their unlimited, long-term memory.

The problem with existing workbooks is that they were designed to rely on a random arrangement of multiplication facts, and they try to use “drill and kill” to get students to memorize them. An example might look like something the random assortment of facts below:

| | | | | | | | | |
|---|---|---|---|---|---|---|---|---|
| 3 | 7 | 4 | 2 | 9 | 6 | 5 | 2 | 8 |
| × 7 | × 7 | × 7 | × 7 | × 7 | × 7 | × 7 | × 7 | × 7 |
| 4 | 6 | 9 | 3 | 7 | 5 | 8 | 1 | 0 |
| × 7 | × 7 | × 7 | × 7 | × 7 | × 7 | × 7 | × 7 | × 7 |

Unfortunately, without a system, students perceive these practice exercises simply as just a long string of random facts, and as shown earlier, these long strings are quickly lost from short-term memory and never enter long-term memory. Students then become quickly frustrated with math as they have to resort to using times tables, counting on their fingers, or using a calculator, as they feel their ability to memorize is inadequate. Additionally, it takes repeated practice and rehearsal in order for a fact to go from short-term memory into long term-memory. Unfortunately, repeating an excessively long, easily-forgettable list is ineffective, but that is just how existing math materials are designed. There must be a better way.

### The Method Offers a Better Way of Creating More Effective Math Worksheets

This new process for creating more effective worksheets that actually promote memory and learning instead of frustrating students is based on the premise that short-term memory in humans is limited and that practice and rehearsal are needed for facts to move from short-term memory into long-term memory.

To illustrate this premise, notice that this string of ten numbers is difficult to memorize: 3 2 3 5 2 8 8 1 6 7. This is why phone companies do not display phone numbers in this way. Instead, they break them up into shorter, more easily remembered groups: (323) 528-8167. When someone tries to memorize this phone number, they rehearse (323) first, then rehearse 528, then rehearse 8167. This shows that shorter lists are easier to remember than longer ones.

In order to design a more effective math worksheet, short lists of facts are systematically generated (as opposed to long lists of random facts), then sufficient practice is provided for students in order for facts to go from short-term memory into long-term memory. The process for the systematic generation of facts is described below.

For every set of single-digit multiplication facts that students need to learn, they must memorize a single digit multiplied by ten other single digits. To revisit the “sevens” as an illustration, students must remember 7 multiplied by all 10 single digits from 0 through 9.
0
1
2
3
4
5
6
7
8
9

However, remember that long strings of numbers are difficult to retain in short term memory and do not make it into long-term memory. Therefore, this list can be systematically broken up into three columns as shown below:

| | | |
|---|---|---|
| 1 | 4 | 7 |
| 2 | 5 | 8 |
| 3 | 6 | 9 |

The 0 is treated separately.
The first column showing 1, 2, 3 contains the easiest facts to memorize.
The second column showing 4, 5, 6 contains the medium-difficulty facts.
The third column showing 7, 8, 9 contains the hardest facts to memorize.

Now, going across rows from left to right, the following three-digit numbers can be created:
147
258
369
   Each of these three-digit numbers contains an easy-to-memorize fact, a medium fact, and a difficult fact. In 147, for example, the 1 is from the easy column, the 4 is from the medium column, and the 7 is from the difficult column.

These numbers are then repeated six times going across the page, as shown below:

| | | | | | |
|---|---|---|---|---|---|
| 147 | 147 | 147 | 147 | 147 | 147 |
| 258 | 258 | 258 | 258 | 258 | 258 |
| 369 | 369 | 369 | 369 | 369 | 369 |

The reason that the number is repeated six times going across the pages is that for three-digit numbers containing the same digits (1, 4, and 7, for example) there are six possible permutations that the digits can be arranged in in order to create a new number (three possible numbers in the hundreds place value multiplied by 2 possible numbers remaining in the tens place value multiplied by one possible number remaining in the ones place value equals six permutations).

For 1, 4, and 7, those permutations are:
147, 471, 714, 741, 417, and 174
   All six of these permutations are then used to systematically rearrange the digits in the worksheet as shown in the example below:

| | | | | | |
|---|---|---|---|---|---|
| 147 | 471 | 714 | 174 | 741 | 417 |
| 258 | 582 | 825 | 285 | 852 | 528 |
| 369 | 693 | 936 | 396 | 963 | 639 |

The six permutations for the digits 1 (the easy fact to memorize), 4 (medium), and 7 (the hard fact to memorize) are as follows in the table below:

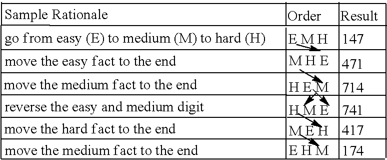

Now that all the permutations are complete, multiply all the numbers by 7 in order to automatically generate a worksheet that better promotes memorization, as explained below.

| | | | | | |
|---|---|---|---|---|---|
| 147 | 471 | 714 | 741 | 417 | 174 |
| × 7 | × 7 | × 7 | × 7 | × 7 | × 7 |
| 258 | 582 | 825 | 852 | 528 | 285 |
| × 7 | × 7 | × 7 | × 7 | × 7 | × 7 |
| 365 | 693 | 936 | 963 | 639 | 396 |
| × 7 | × 7 | × 7 | × 7 | × 7 | × 7 |

When students complete the first row of problems going from left to right, they are now no longer faced with a long string of random, hard-to-remember facts. Instead, it systematically has students practice a short list of three multiplication facts at a time:
7×7 (the hard fact)
7×4 (medium)
7×1 (easy)

The practice and rehearsal that is needed for these facts to go into long-term memory is present because these three facts and only these three facts are repeated six times going across from left to right. This prevents the brain from being cognitively overloaded because students can focus on just a small set of facts until it goes into long-term memory.

On the back of the page, students are instructed to write the products of their “sevens” multiplication facts as shown below:
7
14
21
28
35
42
49
56
63
70

When students complete the first problem . . .
147
×7
   . . . if they have not memorized that 7×7=49, they must flip the page and physically count “seven times” going down the list, and they will see that the answer “seven times” seven equals 49.

On the second problem . . .
471
×7
   . . . , if students forget the answer to 7×7 (remember, short-term memory is lost easily and 7×7=49 is quickly forgotten because students need to put the next fact, 7×4=28, into their short-term memory) they must flip and count “seven times.” Again, they will see that the answer is 49.

When they go through the remaining problems in the row . . .

| | | | |
|---|---|---|---|
| 714 | 741 | 417 | 174 |
| × 7 | × 7 | × 7 | × 7 |

. . . they will encounter 7×7 four more times. Every time they flip the page and count “seven times,” they will find that the answer is always 49.

Students will find that it is inconvenient to keep having to flip the page, physically count “seven times,” and always arrive at the same answer of 49. At this point, the brain would rather just memorize that 7×7=49. At the beginning of the row, students may not have memorized this fact, but by the time they reach the end of the row, they will have the fact memorized because it is far more convenient to do so.

A worksheet designed in this way makes it inconvenient for students not to remember their facts, and as a result, the brain will prefer memorization. This is how a worksheet designed in this way helps students take a small, systematically presented set of facts (an easy fact, a medium fact, and a hard fact) and gives them the rehearsal they need to move the facts from short-term memory to long-term memory.

The “sevens” worksheet that was created above can now be used to create the “eights” worksheet, which will also help students more easily memorize their facts because it is not just a random collection of facts.

| | | | | | |
|---|---|---|---|---|---|
| 147 | 471 | 714 | 741 | 417 | 174 |
| × 8 | × 8 | × 8 | × 8 | × 8 | × 8 |
| 258 | 582 | 825 | 852 | 528 | 285 |
| × 8 | × 8 | × 8 | × 8 | × 8 | × 8 |
| 369 | 693 | 936 | 963 | 639 | 396 |
| × 8 | × 8 | × 8 | × 8 | × 8 | × 8 |

Other variations can be created using this process as well by using different combinations of easy, medium, and hard facts. For example, using:
3, 2, and 1 as the easy facts,
4, 5, and 6 as the medium facts, and
8, 9, and 7 as the hard facts

The following systematic worksheet can be automatically generated:

| | | | | | |
|---|---|---|---|---|---|
| 348 | 483 | 834 | 843 | 438 | 384 |
| × 8 | × 8 | × 8 | × 8 | × 8 | × 8 |
| 259 | 592 | 925 | 952 | 529 | 295 |
| × 8 | × 8 | × 8 | × 8 | × 8 | × 8 |
| 167 | 671 | 716 | 761 | 617 | 176 |
| × 8 | × 8 | × 8 | × 8 | × 8 | × 8 |

In fact, other combinations of difficulty can be used (such as medium, medium, and medium), but it is more effective to focus on one easy fact, one medium fact, and one hard fact.

The order of the permutations used can also be presented in varying orders in order to create unique worksheets every time that still use the principle of practicing only a small set of facts repeatedly to make the transition from short-term to long-term memory easier.

To provide students with practice multiplying by zero, a zero can be placed systematically within the facts. For example, taking the first problem from above, a zero can be placed in the ones place value, the tens place value, and the hundreds place value to generate the following variations:
3480
×8
3408
×8
3048
×8

The method described in this patent application is not limited to paper worksheets, but can also be used in a computer-based program or mobile device-based app in which the software will automatically generate the same systematic series of multi-digit problems for students to practice their times tables rather than the ineffective, random collection of facts that are presented in traditional mathematics programs.

### The System of the Invention

In another aspect of the invention, the invention is a system for carrying out the method of the invention. In one aspect of such system, the invention is a system for preparing systematized groupings of multiplication memorization problems comprising:

a) a tangible processor programed to:
i) separate the integers 1-9 into three groups of integers, a first group consisting of 1, 2 and 3, a second group consisting of 4, 5 and 6 and a third group consisting of 7, 8 and 9; and
ii) assemble a grouping of multiplication memorization problems wherein in each problem (A) the multiplier is an integer between 1 and 9 (multi-digit multipliers can also be used once the single digit multipliers have been mastered by students), and (B) the multiplicand consists of a plurality of integers, including one integer from each of the three groups of integers;

wherein the multipliers in the grouping of multiplication memorization problems are the same, and wherein the multiplicands in the grouping of multiplication memorization problems are different from one another; and
b) a display device for displaying the grouping of multiplication memorization problems.

In the system, the tangible processor can be any of a wide variety of programmable computing devices presently known to the art or which are later made known to the art.

Typically, the tangible processor is a programmable computer or portable communications device.

A software program is loaded within the tangible processor to accept any necessary user input and instruct the tangible processor as to how to create the worksheets using the method described above.

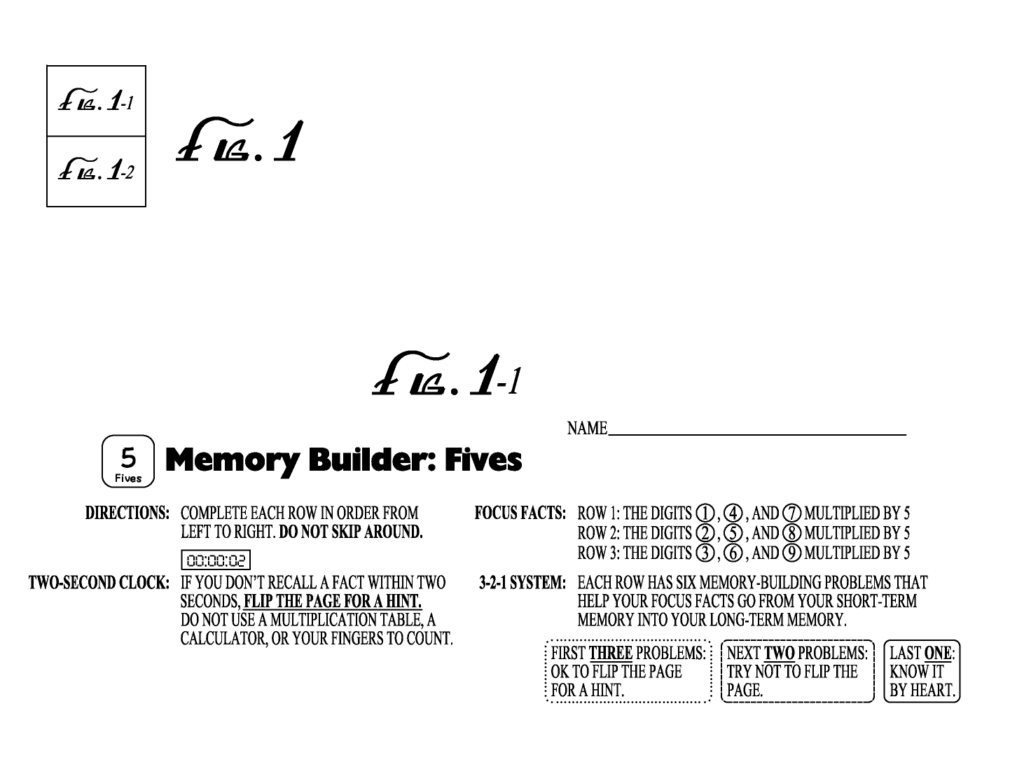

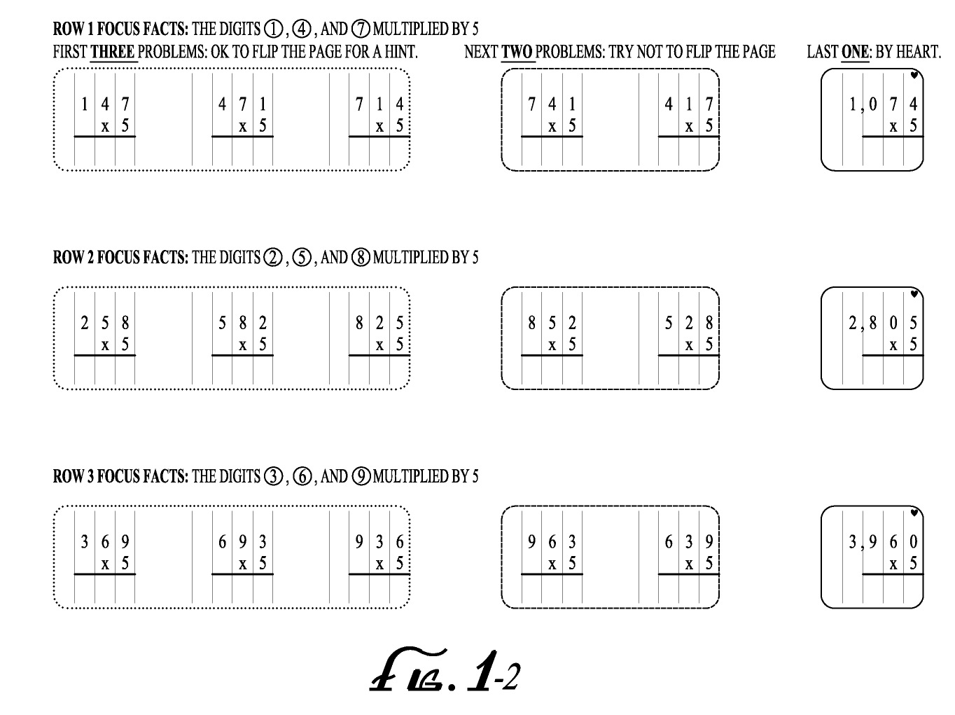

FIG. 1 illustrates a hard copy worksheet for practicing multiplying by 5 printed out on paper.

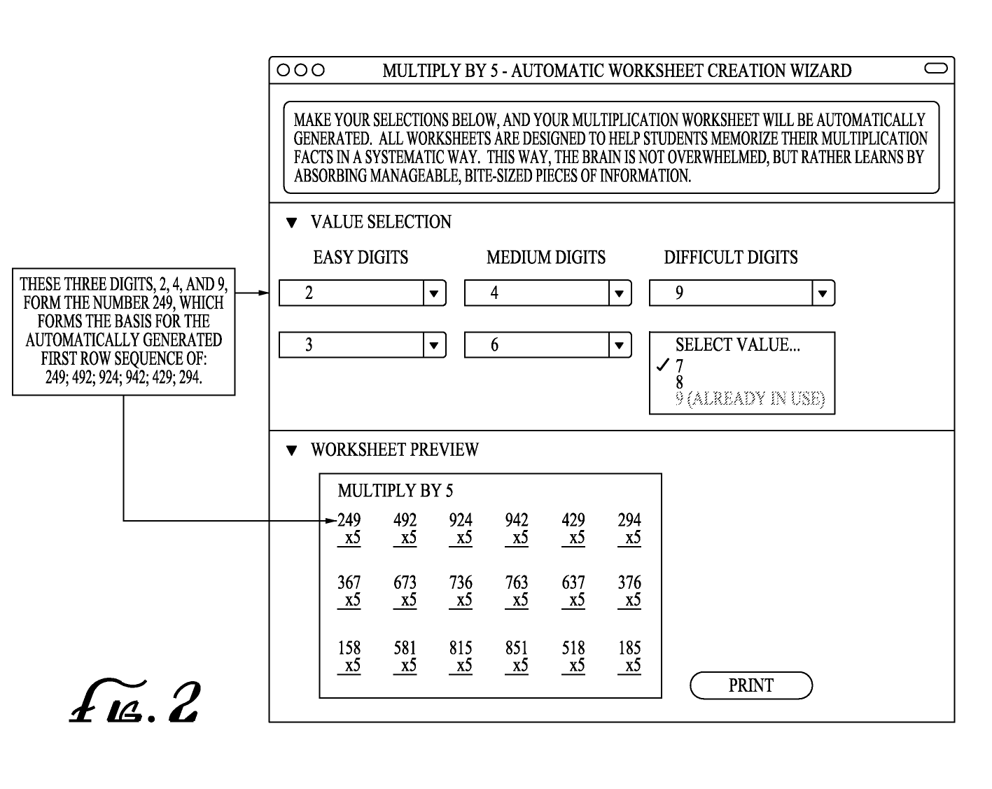

FIG. 2 illustrates an interactive display page from one such software program. In this example, the user has chosen to prepare a worksheet for practicing multiplying by 5. The display page displays a 3×2 array of value selections. The user is invited to choose values for each of the six boxes via pull down menus—entering an integer of 1, 2 or 3 in the boxes in the first column of the array, entering an integer of 4, 5 or 6 in the boxes in the second column of the array and entering an integer of 7, 8 or 9 in the boxes in the third column of the array. In this example, duplicate values are prohibited—making the entry of values in a third row of the array unnecessary since such values are automatically determined by the user's previous choices. After the user has made his or her value selection, the software program automatically generates a worksheet and displays it in a Worksheet Preview box. In this example, if the worksheet is acceptable, the user presses a PRINT button to print out one or more paper copies of the worksheet.

The display device can be any device presently known or known in the future displaying the output of the tangible processor. Thus, the display device can be a computer monitor, which is either interactive or non-interactive. The display device can also be a computer printer, typically capable of printing out paper copies displaying the output of the tangible processor.

### CONCLUSION

Too many students fail to learn their multiplication facts in elementary school, which leads to academic struggles in middle school, high school, and into adult life. Students struggle to learn their facts because existing workbooks and curriculum do not have a system to have students learn their facts other than rote memory and “drill and kill” These traditional approaches do not work because they overwhelm the brain's short-term memory and do not give enough practice and rehearsal for facts to enter long-term memory.

This new process for automatically generating systematic worksheets is non-obvious even to educators because all they have known is to use rote memory. It is a process that can be used to generate both paper worksheets as well as digital learning experiences. In a matter of three to four weeks, even young students who use materials generated using this new process can memorize their multiplication facts, and no longer will students have to struggle needlessly for years in math.

Having thus described the invention, it should be apparent that numerous structural modifications and adaptations may be resorted to without departing from the scope and fair meaning of the instant invention as set forth herein above and described herein below by the claims.

What is claimed is:

1. A method of preparing systematized groupings of multiplication memorization problems comprising the steps of:
a) separating the integers 1-9 into three groups of integers, a first group consisting of 1, 2 and 3, a second group consisting of 4, 5 and 6 and a third group consisting of 7, 8 and 9; and
b) assembling a grouping of multiplication memorization problems wherein in each problem (i) the multiplier is an integer between 1 and 9, and (ii) the multiplicand consists of a plurality of integers, including one integer from each of the three groups of integers;
wherein the multipliers in the grouping of multiplication memorization problems are the same; and
wherein the multiplicands in the grouping of multiplication memorization problems are different from one another.

2. The method of claim 1 wherein multi-digit multipliers are used.

3. A system for preparing systematized groupings of multiplication memorization problems comprising:
a) a tangible processor programed to:
i) separate the integers 1-9 into three groups of integers, a first group consisting of 1, 2 and 3, a second group consisting of 4, 5 and 6 and a third group consisting of 7, 8 and 9; and
ii) assemble a grouping of multiplication memorization problems wherein in each problem (A) the multiplier is an integer between 1 and 9, and (B) the multiplicand consists of a plurality of integers, including one integer from each of the three groups of integers;
wherein the multipliers in the grouping of multiplication memorization problems are the same, and wherein the multiplicands in the grouping of multiplication memorization problems are different from one another; and
b) a display device for displaying the grouping of multiplication memorization problems.

4. The system of claim 3 wherein the tangible processor programed to assemble a grouping of multiplication memorization problems having multi-digit multipliers.

5. The system of claim 3, wherein the tangible processor comprises a programmable computer.

6. The system of claim 3 wherein the tangible processor is a portable communications device.

7. The system of claim 3 wherein the display device is a computer monitor.

8. The system of claim 3 wherein the display device is an interactive computer monitor

9. The system of claim 2 wherein the display device is a computer printer.
